(19) United States
(12) Patent Application Publication
(10) Pub. No.: US 2025/0181929 A1
(43) Pub. Date: Jun. 5, 2025

(54) TARGET PREDICTION METHOD USING PRE-TRAINING AND TRANSFER LEARNING, AND TARGET PREDICTION FRAMEWORK FOR PERFORMING SAME

(71) Applicant: Impactive AI, Pohang-si (KR)

(72) Inventors: Charm Gil HONG, Pohang-si (KR); Doo Hee CHUNG, Seoul (KR)

(73) Assignee: Impactive AI, Pohang-si (KR)

(21) Appl. No.: 18/928,581

(22) Filed: Oct. 28, 2024

(30) Foreign Application Priority Data
Dec. 1, 2023 (KR) 10-2023-0172099

(51) Int. Cl. G06N 3/096

(52) U.S. Cl. CPC G06N 3/096

(57) ABSTRACT

Proposed are a target prediction method using pre-training and transfer learning, and a target prediction framework for performing the same, the method including a data input step of inputting prediction datasets related to targets for prediction, a base model training step of training deep learning models by using the prediction datasets input in the data input step, a cluster classification step of classifying the prediction datasets into a plurality of clusters by using SHapley Additive explanations (SHAP) values, and a transfer learning step of inputting the plurality of clusters into the respective deep learning models and retraining respective weights through transfer learning after the cluster classification step, thereby providing an optimal target prediction technique so as to satisfy the diversity of target patterns represented through time series data.

### CROSS REFERENCE TO RELATED APPLICATION

The present application claims priority to Korean Patent Application No. 10-2023-0172099, filed Dec. 1, 2023, the entire contents of which are incorporated herein for all purposes by this reference.

### BACKGROUND OF THE INVENTION

### Field of the Invention

The present disclosure relates to a target prediction method and a target prediction framework for performing the same, wherein items whose influence of input variables are similar to each other are clustered, a prediction model for each cluster is generated, and then a modeling framework reflecting the characteristic for each item is provided, so that an optimal target prediction technique may be provided to satisfy the diversity of target patterns represented through time series data.

### Description of the Related Art

There may be data on various kinds of targets required for corporate activities, and actually, the need for predicting such targets is greatly demanded by companies in particular.

Especially, in a case where the targets are considered as demand, the need for a wide variety of predictions arises as described below.

For example, a company may cope with various uncertain factors by maintaining safety stock, and the maintaining of the safety stock through appropriate demand forecasting may lead to cost reduction and service level improvement for the company. Accordingly, target prediction models are being introduced in various industrial environments. For example, relevant models have been widely used for target prediction for a long time. Such models include: an Auto-Regressive Integrated Moving Average (ARIMA) model designed to collect past records and analyze patterns to predict the future; a linear model such as linear regression using a sliding window method; and an ensemble model such as random forest.

Recently, research on predicting time series data through artificial neural networks of Recurrent Neural Network (RNN) series models is also actively being conducted, and such models based on this research are believed to provide higher accuracy than existing conventional models, thereby receiving much attention in the field of time series data analysis.

However, as described above, due to the diversity of demand patterns represented through time series data, it is difficult to provide an optimal demand forecasting technique generally applicable, and actually, the research on the optimal demand forecasting technique is continuously being conducted.

### DOCUMENTS OF RELATED ART

### Patent Documents

(Patent Document 1) Korean Patent No. 10-2050855 (Registered on Nov. 26, 2019)

### SUMMARY OF THE INVENTION

An objective of the present disclosure is to provide a target prediction method and a target prediction framework for performing the same, wherein items whose influence of input variables are similar to each other are clustered, a prediction model for each cluster is generated, and then a modeling framework reflecting the characteristic for each item is provided, so that an optimal target prediction technique may be provided to satisfy the diversity of target patterns represented through time series data.

In addition, another objective of the present disclosure is to provide a target prediction method and a target prediction framework for performing the same, wherein a deep learning model including Multi-Layer Perceptron (MLP) or Feed Forward Neural Network (FFNN) is used to predict a target for each item, a model for each cluster is generated after classifying items whose magnitudes of influence for each input variable of the model are similar to each other by using SHapley Additive explanations value (SHAP) values, a single model trained for all the items is used as a pre-trained model, and transfer learning is applied for each cluster to produce final models, whereby a problem of underfitting due to lack of data that occurs depending on the clusters may be effectively solved.

The objectives of exemplary embodiments of the present disclosure are not limited to the above-mentioned objectives, and other different objectives not mentioned herein will be clearly understood by those skilled in the art from the following description.

According to one aspect of the present disclosure, there is provided a target prediction method of the present disclosure, the method including: a data input step of inputting prediction datasets related to targets for prediction; a base model training step of training deep learning models by using the prediction datasets input in the data input step; a cluster classification step of classifying the prediction datasets into a plurality of clusters by using SHapley Additive explanations (SHAP) values; and a transfer learning step of inputting the plurality of clusters into the respective deep learning models and retraining respective weights through transfer learning after the cluster classification step.

In addition, according to one aspect of the present disclosure, each deep learning model may include a Multi-Layer Perceptron (MLP) model or a Feed Forward Neural Network (FFNN).

In addition, according to one aspect of the present disclosure, the cluster classification step may perform clustering and classification according to influence of variables corresponding to the SHAP values for each data of the prediction datasets.

In addition, according to one aspect of the present disclosure, the cluster-specific classification step may perform the clustering by using the SHAP values, and classify the prediction datasets for each of the plurality of clusters by applying a K-means clustering method.

In addition, according to one aspect of the present disclosure, the transfer learning step may use a neural network model as a pre-trained model, and perform fine tuning for each of the plurality of clusters.

In addition, according to one aspect of the present disclosure, the targets may be demand.

According to another aspect of the present disclosure, there is provided a target prediction framework for performing a target prediction method in a form including the steps described above.

In the present disclosure, there is provided an effect that items whose influence of input variables are similar to each other are clustered, a prediction model for each cluster is generated, and then a modeling framework reflecting the characteristic for each item is provided, so that an optimal target prediction technique may be provided to satisfy the diversity of target patterns represented through time series data.

In addition, in the present disclosure, there is provided another effect that a deep learning model including MLP or FFNN is used to predict a target for each item, a model for each cluster is generated after classifying items whose magnitudes of influence for each input variable of the model are similar to each other by using SHAP values, a single model trained for all the items is used as a pre-trained model, and transfer learning is applied for each cluster to produce final models, whereby a problem of underfitting due to lack of data that occurs depending on the clusters may be effectively solved.

### BRIEF DESCRIPTION OF THE DRAWINGS

FIG. 1 is a flowchart illustrating a target prediction method according to an exemplary embodiment of the present disclosure.

FIGS. 2 to 4 are views illustrating detailed steps of the target prediction method according to the exemplary embodiment of the present disclosure.

### DETAILED DESCRIPTION OF THE INVENTION

Advantages and features of the exemplary embodiments of the present disclosure and the method of achieving the same will become apparent with reference to exemplary embodiments described below in detail in conjunction with the accompanying drawings. However, the present disclosure is not limited to the exemplary embodiments disclosed below, but will be implemented in a variety of different forms. These exemplary embodiments are provided only to complete the present disclosure and to completely inform the scope of the present disclosure to those skilled in the art to which the present disclosure pertains, and the present disclosure is only defined by the scope of the claims. Like reference numerals generally denote like elements throughout the present disclosure.

In the following descriptions of the exemplary embodiments of the present disclosure, it should be noted that, when a detailed description of a known function or configuration may unnecessarily obscure the subject matter of the present disclosure, the detailed description thereof will be omitted. In addition, terms to be described below are terms defined in consideration of functions in the exemplary embodiments of the present disclosure, which may vary according to the intention, custom, etc. of users or operators. Therefore, definitions of these terms should be made on the basis of the content throughout the present specification.

Hereinafter, an exemplary embodiment of the present disclosure will be described in detail with reference to the accompanying drawings.

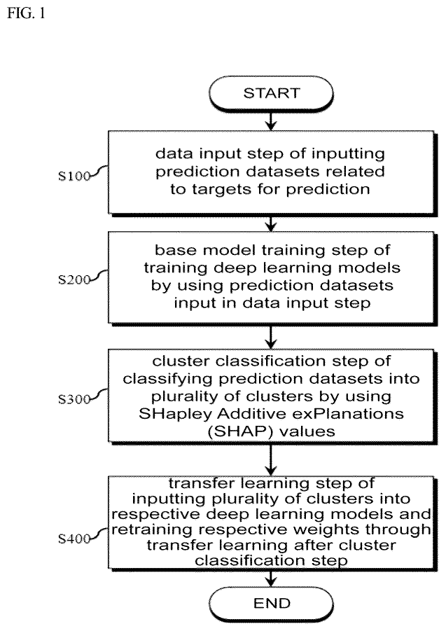

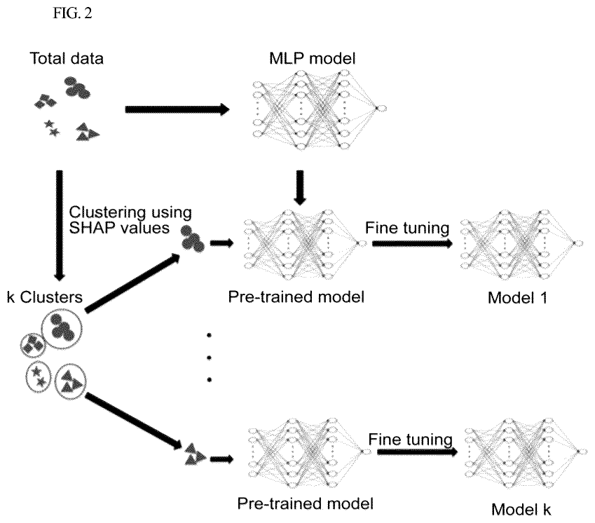

FIG. 1 is a flowchart illustrating a target prediction method according to an exemplary embodiment of the present disclosure. FIGS. 2 to 4 are views illustrating detailed steps of the target prediction method according to the exemplary embodiment of the present disclosure.

Referring to FIGS. 1 to 4, according to the exemplary embodiment of the present disclosure, the target prediction method may include: a data input step S100, a base model training step S200, a cluster classification step S300, a plurality of transfer learning steps S400, etc.

The data input step S100 is a step of inputting prediction datasets for target prediction. In a case of exemplifying targets as demand as illustrated in FIG. 2, inputting sales and inventory-related datasets as demand forecast datasets (i.e., Total data) is performed in order to forecast the demand (i.e., shipment volumes).

In the corresponding exemplary embodiment, for example, the prediction datasets uses the sales and inventory datasets, but may each include information such as price per item, monthly shipment volumes, and import status, and may use datasets corresponding to items (e.g., 541 items) including all information for the entire data collection period (e.g., 53 months, etc.) among all items.

In addition, as an example, in a case where a target to be predicted is defined as a shipment volume indicating a safety stock quantity for a preset period (e.g., four months, etc.), a variable MOVING_SUM that adds up shipment volumes for months from three months before a corresponding month of performing target prediction to a current month may be used, and the changes of a shipment volume sum variable MOVING_SUM for the past year may be used as an input variable in order to predict the corresponding variable.

In addition, as input variables for predicting a shipment volume sum variable MOVING_SUM of a corresponding month, a total of 17 variables may be used, including shipment volume sum variables (MOVING_SUMs) for respective months from 1 month ago to 12 months ago, average shipment volume sum variables (MOVING_SUMs) for respective months from 2, 3, 6, and 12 months ago, and finally a cumulative average of the shipment volume sum variables (MOVING_SUMs) up to the corresponding month.

For example, a period for calculating a shipment volume sum variable MOVING_SUM among data from August 2018 to December 2022 is a total of 50 months from October 2018 to November 2022, and in order to use the input variables, a period of at least one year ago is used to calculate from a target variable, whereby a period that may be used as the target variable is a total of 38 months from October 2019 to November 2022, so after data preprocessing is performed, 38instances per item, i.e., a total of 20,558 instances, are secured and may be input as prediction datasets.

Here, since an average value of the shipment volume sum variable MOVING_SUM by item is between 0.1 and 100,000, a difference in scale by item may be very large.

The base model training step S200 is a step of training deep learning models by using the input prediction datasets. As illustrated in FIG. 2, the deep learning models may include, for example, a Multi-Layer Perceptron (MLP) model or a Feed Forward Neural Network (FFNN) model.

Here, the MLP is composed of an input layer, hidden layers, and an output layer. The number of hidden layers and the number of neurons may be set and configured by a user as needed, and each neuron in the hidden layers has a weight and a bias value. In this way, after calculating a linear combination of input values, base model training using prediction datasets may be performed in a way of calculating an output value through a nonlinear activation function (e.g., sigmoid, ReLU, hyperbolic tangent, etc.).

In addition, the FENN may perform the base model training using the prediction datasets in a process similar to that of the MLP, but information being processed is transmitted in only one direction, data may be transmitted from an input layer to an output layer, and each hidden layer may perform intermediate calculation during such a transmission process.

Meanwhile, in the training and evaluation of each deep learning model, a loss function may be used to measure differences between actual values and predicted values of a model and then minimize the differences. A gradient of the loss function may be calculated by using a back propagation algorithm, and loss may be reduced by adjusting weights and biases of the model. When a Mean Squared Error (MSE), which is a function mainly used in regression problems, is used, there is a disadvantage in that the influence of items having large units of shipment volume becomes excessively large. Therefore, a Mean Absolute Percentage Error (MAPE), which represents an average value of percentage errors between the actual values and the predicted values, may be used.

In the base model training step S200 described above, after performing the base model training using the prediction datasets, these deep learning models as pre-trained models may respectively be provided to the plurality of transfer learning steps S400 thereafter.

The cluster classification step S300 is a step of classifying the prediction datasets into the plurality of clusters by using SHapley Additive explanations (SHAP) values. Each SHAP value is a value describing how each feature affects a predicted value in a machine learning model. In order for a decision-making mechanism to predict a model for each similar item, the SHAP values of the input variables may be used to cluster the prediction datasets, which is provided in the data input step S100, by items having similar influence of the variables.

As illustrated in FIG. 2, in such a cluster classification step S300, the prediction datasets may be clustered and classified according to the influence of the variables corresponding to the SHAP values for respective pieces of data in the prediction datasets.

In addition, in the cluster classification step S300, the clustering is performed by using the SHAP values, and the prediction datasets may be classified for each of the plurality of clusters by applying a K-means clustering method.

For example, in the cluster classification step S300, the SHAP values may be calculated with a total of 20,558 instances calculated for all the items of the prediction datasets by utilizing an MLP model, which is a deep learning model. The clustering is performed by using the SHAP values of 17 input variables. Absolute values of the calculated SHAP values are taken, an average for each item is calculated to obtain an average vector of the SHAP values for each item, and then the items may be classified into a total of four clusters by using the K-means clustering algorithm.

Here, the K-means clustering algorithm may find patterns in the data and classify the pieces of data having similar characteristics into the same group or cluster. A plurality of pieces of data may be effectively classified in a way of determining K number of clusters, randomly initializing K number of cluster centers, respectively assigning the pieces of data to the closest cluster centers on the basis of Euclidean distances, etc., and calculating an average of data points belonging to each cluster to update to new cluster centers.

In addition, an elbow technique may be used in determining the number of clusters, which is K, in the K-means clustering algorithm. The elbow technique may select the number of clusters K, prepare candidate sets of K values, perform K-means clustering for each K value, and calculate the fitness (or cost function values) for the results of clustering. Each cost function value may be calculated by using inertia or distortion, which is the sum of distances between respective data points and the centers of corresponding clusters.

Thereafter, K that is the number of clusters may be selected in a way of drawing inertia values for the respective K values as a graph and then detecting a point where the graph bends like an elbow. Here, an elbow point is a point where a cost function value decreases sharply, thereby being considered as a point indicating the optimal number of clusters.

Each of the plurality of transfer learning steps S400 that may be performed individually for respective clusters is a step of inputting the plurality of clusters into respective deep learning models and retraining respective weights through transfer learning. As illustrated in FIG. 2, each deep learning model is used as a pre-trained model, but fine tuning may be performed for each of the plurality of clusters.

In such a plurality of transfer learning steps S400 that may be performed individually for the respective clusters, the deep learning models trained with all the items by using the prediction datasets may be used as the pre-trained models, and the weights may be retrained by applying the fine tuning of transfer learning to the entire layer for each of the plurality of clusters.

For example, in such a plurality of transfer learning steps S400 that may be performed individually, since a single model created to predict all the items through training using the prediction datasets has difficulty in reflecting all the characteristics of various items, a part or all of the single model that has already been trained through the transfer learning may be used to solve a new problem, and through fine tuning, some or all of the layers of the pre-trained model (i.e. the single model) may be retrained by reflecting the SHAP values for each of the plurality of clusters.

In this case, in such a plurality of transfer learning steps S400 that may be performed individually, the retraining is performed by reflecting the weights corresponding to respective SHAP values in a way of performing fine tuning for each of the plurality of clusters classified by using the respective MLP models as the pre-trained models, whereby the problem of underfitting due to lack of data that occurs due to the clustering may be effectively solved.

Through the process described above, in such a plurality of transfer learning steps S400 that may be performed individually, final target prediction models (i.e., Model 1 to Model k) may be generated as illustrated in FIG. 2.

A description on the implementation of the target prediction method and the target prediction framework for performing the target prediction method according to the exemplary embodiment of the present disclosure as described above, and a description on simulations and results predicted by using actual data thereof will be given below.

First, in a corresponding exemplary embodiment, targets may be defined as demand, and prediction datasets may be defined as demand forecast datasets.

Thereafter, MLP models may be used as artificial intelligence models to be trained by using the demand forecast datasets. The MLP models are implemented by using Python's PyTorch library, and optimal hyperparameters are selected through Optuna.

Ranges for each hidden layer are set as follows: the number of nodes is [30, 150], learning_rate is [1e-5, 1e-1], weight_decay is [1e-5, 1e-1], and drop_out is [5e-2, 5e-1]. In addition, ranges for optimal hyperparameter values based on MAPE are set as follows: the number of nodes is [71, 119], learning_rate is 0.0003, weight_decay is 0.01, and drop_out is 0.06. The epoch is 100, and AdamW is used as an optimizer so as to conduct training.

Here, an MAPE is used as a loss function because an MSE, which is a function mainly used in regression problems, has a disadvantage of excessively increasing the influence of items having large units of shipment volume.

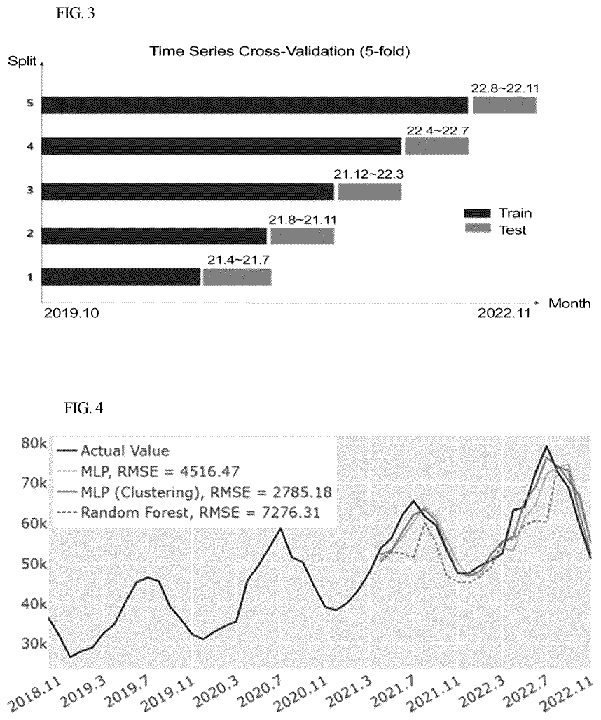

Meanwhile, in order to perform cross-validation of time series data in an evaluation method, data is split in the manner illustrated in FIG. 3, each test dataset (i.e., Test set) is organized into 4-month units, and a total of 20 months from April 2021 to November 2022 are used as the test datasets for 5-fold cross-validation.

In addition, as evaluation indicators, Root Mean Squared Error (RMSE), MAPE, MAE, R-squared, and the like are used, and by using a tree-based random forest model, their performances are compared with performance of a case where a target variable simply organized from a month ago is used as a predicted value as a baseline.

When describing the results of simulation as described above, Table 1 below shows predicted results for the entire item, that is, averages and standard deviations for each evaluation indicator of 5-fold cross-validation.

TABLE 1

| | Prediction | | | |
|---|---|---|---|---|
| | with one- | | | |
| | month-ago | | | Transfer |
| | data | Random Forest | MLP | Learning |
| RMSE | 345.75 ± 76.38 | 458.08 ± 153.77 | 278.21 ± 91.41 | 235.38 ± 57.70 |
| MAPE | 16.01 ± 0.80 | 16.49 ± 0.90 | 12.16 ± 0.80 | 11.87 ± 0.56 |
| MAE | 56.97 ± 8.63 | 66.74 ± 13.80 | 48.31 ± 11.81 | 43.18 ± 7.35 |
| R- | 0.992 ± 0.002 | 0.986 ± 0.007 | 0.995 ± 0.002 | 0.997 ± 0.001 |
| squared | | | | |

Referring to Table 1, it may be confirmed that the transfer learning model has the best performance in all the indicators of RMSE, MAPE, MAE, and R-squared.

Moreover, in addition to the results for the entire item, the MAPE and RMSE are calculated for each item in the MLP and transfer learning model in order to perform comparison of individual item prediction performance, providing results as follows. It may be confirmed that there are 14 out of 541 items whose RMSE after the transfer learning is performed is decreased by more than 20% and also there are no items whose RMSE after the transfer learning is performed is increased by more than 20% compared to the RMSE before the clustering is performed. It may be confirmed that the number of items for which the MAPE decreased and increased by more than 20% after the transfer learning is performed is 18 and 2, respectively, and there is improvement in prediction performance for each item. It may be confirmed that the prediction performance of items having strong periodicity is greatly improved in the prediction after the transfer learning is performed as shown in FIG. 4.

When the simulation results as described above are analyzed, it may be confirmed that the transfer learning model shows the best prediction performance in all the evaluation indicators in the average of 5-fold cross-validation, followed by the MLP, prediction using the values from one month ago, and random forest in that order.

Here, it may be determined that the reason why the random forest model, which is a tree-based ensemble model, performs worse than the prediction simply using the values from one month ago may be attributed to a strong correlation between the input variables used therefor.

In addition, it may be confirmed that the model applying the proposed transfer learning technique performs better than the MLP single model not only in the average of the entire item prediction but also in the item-by-item prediction. This shows that the decision making mechanism better reflects individual characteristics by performing the clustering for each similar item and representing the results with multiple models rather than one model.

Meanwhile, in a case where an MLP model is trained for each cluster without using the transfer learning technique, the result shows that RMSE is 266.93±58.94 and MAPE is 13.65±0.94, indicating that the performance is decreasing or increasing slightly compared to the single model. In a case where a model for k number of clusters is used, training data thereof is arithmetically reduced to 1/k, so there is a problem of underfitting that occurs due to the insufficient training data when training the cluster-specific MLP model rather than the transfer learning. It may be confirmed that this problem may be effectively solved through the technique of predicting the targets (i.e., the demand in the exemplary embodiment) according to the exemplary embodiment of the present disclosure.

Therefore, according to the exemplary embodiment of the present disclosure, items whose influence of input variables are similar to each other are clustered, a prediction model for each cluster is generated, and then a modeling framework reflecting the characteristic for each item is provided, so that an optimal target prediction technique may be provided to satisfy the diversity of target patterns (e.g., demand patterns) represented through time series data.

In addition, according to the exemplary embodiment of the present disclosure, in a case where the targets are demand, there is another effect that a deep learning model including MLP or FFNN is used to predict a target for each item, a model for each cluster is generated after classifying items whose magnitudes of influence for each input variable of the model are similar to each other by using SHAP values, a single model trained for all the items is used as a pre-trained model, and transfer learning is applied for each cluster to produce final models, whereby a problem of underfitting due to lack of data that occurs depending on the clusters may be effectively solved.

In addition, in the case of various target prediction methods described above, these methods may be performed by a computing device including at least one processor, and the computing device may also include, in addition to the processor, a storage medium in which specific steps of the target prediction method may be read/written/stored.

As an exemplary embodiment, the computing device may be an AI server capable of performing AI learning, and the processor may include various processing units such as a CPU and a GPU.

In addition, in the case of the target prediction framework that performs the various target prediction methods described above, a framework in computer programming in general refers to as a comprehensive abstract structure that allows reuse of structurally fixed parts, while allowing application-specific functionality to be optionally implemented by additional user-written code, but this framework refers to a concept that includes not only such a comprehensive abstract structure, but also a specific hardware system, i.e., a device, in which the aforementioned abstract structure is implemented in the form of a software platform.

In the above description, various exemplary embodiments of the present disclosure have been presented and described, but the present disclosure is not necessarily limited thereto, and those skilled in the art to which the present disclosure pertains will readily recognize that various substitutions, modifications, and changes are possible within the scope of the technical spirit of the present disclosure.

What is claimed is:

1. A target prediction method performed by a computing device comprising at least one processor, the method comprising:
a data input step of inputting prediction datasets related to targets for prediction;
a base model training step of training deep learning models by using the prediction datasets input in the data input step;
a cluster classification step of classifying the prediction datasets into a plurality of clusters by using SHapley Additive explanations (SHAP) values; and
a transfer learning step of inputting the plurality of clusters into the respective deep learning models and retraining respective weights through transfer learning after the cluster classification step.

2. The method of claim 1, wherein each deep learning model comprises a Multi-Layer Perceptron (MLP) model or a Feed Forward Neural Network (FFNN).

3. The method of claim 2, wherein the cluster classification step performs clustering and classification according to influence of variables corresponding to the SHAP values for each data of the prediction datasets.

4. The method of claim 3, wherein the cluster-specific classification step performs the clustering by using the SHAP values, and classifies the prediction datasets for each of the plurality of clusters by applying a K-means clustering method.

5. The method of claim 4, wherein the transfer learning step uses a neural network model as a pre-trained model, and performs fine tuning for each of the plurality of clusters.

6. The method of claim 5, wherein the targets are demand.

7. A target prediction framework for performing a target prediction method of claim 1.

8. A target prediction framework for performing a target prediction method of claim 2.

9. A target prediction framework for performing a target prediction method of claim 3.

10. A target prediction framework for performing a target prediction method of claim 4.

11. A target prediction framework for performing a target prediction method of claim 5.

12. A target prediction framework for performing a target prediction method of claim 6.
